(19) United States
(12) Patent Application Publication
(10) Pub. No.: US 2011/0290119 A1
(43) Pub. Date: Dec. 1, 2011

(54) ANTIMICROBIAL ELECTRET WEB

(75) Inventors: Caroline M. Ylitalo, Stillwater, MN (US); Narina Y. Stepanova, Inver Grove Heights, MN (US); John M. Sebastian, Oakdale, MN (US); Sonja K. Belgrade, Stillwater, MN (US); David R. Holm, Hudson, WI (US); Fuming B. Li, Woodbury, MN (US)

(73) Assignee: 3M Innovative Properties Company, St. Paul, MN (US)

(21) Appl. No.: 13/143,576

(22) PCT Filed: Feb. 5, 2010
(86) PCT No.: PCT/US10/23266

§ 371 Date: Jul. 7, 2011

Related U.S. Application Data
(60) Provisional application No. 61/154,026, filed on Feb. 20, 2009.

(51) Int. Cl. B01D 46/00; B05D 3/10; B05D 5/00; B05D 3/14

(52) U.S. Cl. 96/226; 427/532

(57) ABSTRACT

Antimicrobial electret material are described. In some embodiments, the materials comprise a unitary web comprising an antimicrobial surface treatment and having certain properties. In other embodiments, an antimicrobial electret material is described comprising an electret web comprising an antimicrobial surface treatment wherein the surface treatment comprises a sparingly soluble silver-containing compound, a photosensitive antimicrobial agent that forms reactive oxygen species, a biguanide compound, or a combination thereof.

### BACKGROUND

Electret articles—that is, dielectric articles that exhibit at least quasi-permanent electric charge—are known to exhibit good filtration properties. The electric charge enhances the ability of the nonwoven web to capture particles that are suspended in a fluid that passes through the web. The nonwoven web typically contains fibers that comprise dielectric—that is, nonconductive—polymers. These articles have been fashioned in a variety of constructions, but for air filtration purposes, the articles commonly take the form of a nonwoven polymeric fibrous web. An example of such a product is the Filtrete™ brand furnace filter sold by the 3M Company. Nonwoven polymeric electret filters also have been used in personal respiratory protection devices.

JP2001347117 describes an antimicrobial electret material and filter. The material is a synthesized organic polymer containing an arsenic compound with a phenoxy group.

When an antimicrobial agent is incorporated directly into the polymer from which a (e.g. nonwoven) web material is formed, the manufacturer of the nonwoven must incorporate such material change into their manufacturing process.

JP 200262820 describes an air-cleaning filter provided by forming and processing a honeycomb double layer base material comprising an electret layer and an antimicrobial mildewproof layer.

### SUMMARY

Industry would find advantage in (e.g. unitary) web materials having a combination of electret and antimicrobial properties. However, it has been found that certain antimicrobial agents can compromise the electret properties. For example, quaternary ammonium salts have been found to dissipate the electrostatic charge. Alternatively, it has been found that the charging of a (e.g. nonwoven) web to impart electret properties can deactivate the antimicrobial efficacy of various antimicrobial agents.

Applying a surface treatment to a conventional (i.e. non-antimicrobial) web material can be advantageous because conventional low cost nonwoven materials can be used as the base material. Further, since the antimicrobial property is incorporated after the non-woven material is made, the kind and amount of antimicrobial can be customized to accommodate different end products and uses.

In some embodiments, antimicrobial electret web materials are described.

The antimicrobial property of the (e.g. unitary) web may be characterized by exhibiting a microbial load reduction of at least about 90% for either gram positive or gram negative pathogens, when tested pursuant to AATCC Method 100-2004.

In some embodiments, the electret charge of the (e.g. unitary) web may be characterized by exhibiting a % penetration ratio of at least 50% when tested pursuant the X-ray Discharge Test (as described in the examples).

In other embodiments, the electret charge of the (e.g. unitary) web may be characterized by exhibiting an initial quality factor of at least 0.3 and the quality factor is at least 50% less than the initial quality factor after 40 minutes when tested pursuant the X-ray Discharge Test (as described in the examples).

In another embodiment, an electret web is described comprising an antimicrobial surface treatment wherein the surface treatment comprises a sparingly soluble silver-containing compound, a photosensitive antimicrobial agent that forms reactive oxygen species, or a combination thereof.

In yet another embodiment, a method of making an antimicrobial electret material is described comprising providing a web; charging the web; and applying an antimicrobial treatment solution to the charged web.

In each of these embodiments, the (e.g. unitary) web may further comprise any one or combination of attributes as described herein. The web preferably comprises an antimicrobial surface treatment. The web is preferably a polymeric (e.g. nonwoven) fibrous web. In some embodiments, the web exhibits a microbial load reduction of at least about 90% or 99% for either gram positive or gram negative pathogens, when tested pursuant to AATCC Method 100-2004. In some embodiments, the web preferably exhibits a Q₀ of at least 0.6 or 1.0 when measured using DOP (dioctyl phthalate) aerosol at a face velocity of 6.9 cm/s. In some embodiments, the web exhibits a charge retention of at least 75%, 80%, 85%, or 90%.

In some embodiments, the unitary web and method comprises a (e.g. sparingly soluble) silver-containing compound, a photosensitive antimicrobial agent that forms reactive oxygen species such as a xanthene dye, or a combination thereof.

### BRIEF DESCRIPTION OF THE DRAWINGS

FIG. 1 is a front perspective view of a disposable respiratory mask 10 that may use electret filter media of the present invention.

FIG. 2 is a cross-section of the mask body 12 illustrated in FIG. 1, showing a fibrous electret filter layer 20.

FIG. 3 is a perspective view of a respiratory mask 24 that has a filter cartridge 28 that may include electret filter media of the present invention.

FIG. 4 is an illustration of a non-fibrous electret article 40 that may be used in connection with the present invention.

### DETAILED DESCRIPTION

### Glossary

In this document:

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is a semi open-ended term in that it excludes only those things or elements that would have a deleterious effect on the performance of the electret article in serving its intended function;

“electret material” means a web that exhibits a quasi-permanent electric charge. The electric charge may be characterized by the X-ray Discharge Test (as described in the examples);

“fibrous” means possessing (e.g. polymeric) fibers and possibly other ingredients;

“nonwoven” means a structure or portion of a structure where the constituents (e.g. fibers) are held together by a means other than weaving;

“unitary web” refers to a single web or the same layer of a multilayered web;

Fibrous web articles suitable for use in this invention can be made from a variety of techniques, including air laid processes, wet laid processes, hydro-entanglement, spun-bond processes, and melt blown processes as known in the art such as described in Van A. Wente, Superfine Thermoplastic Fibers, 48 INDUS. ENGN. CHEM. 1342-46 and in Report No. 4364 of the Naval Research Laboratories, published May 25, 1954, entitled Manufacture of Super Fine Organic Fibers by Van A. Wente et al.

Microfibers, particularly meltblown microfibers, are particularly suitable for use in fibrous webs that are used as filters. As used in this document, “microfiber” means fiber(s) that have an effective diameter of about 25 micrometers or less. Effective fiber diameter can be calculated using equation number 12 in Davies, C. N., The Separation of Airborne Dust and Particles, INST. MECH. ENGN., LONDON PROC. 1B (1952). For filtering applications, the microfibers typically have an effective fiber diameter of less than 20 micrometers, more typically, about 1 to about 10 micrometers. Fibers made from fibrillated films may also be used—see, for example, U.S. Pat. Nos. RE30,782, RE32,171, 3,998,916 and 4,178,157 to Van Turnout.

Staple fibers also may be combined with the microfibers to improve web loft, that is, to reduce its density. Reducing web density can lower the pressure drop across the web, making it easier for air to pass through the filter. Lower pressure drops are particularly desirable in personal respiratory protection devices because they make the respirator more comfortable to wear. When the pressure drop is lower, less energy is needed to draw air through the filter. In a typical nonwoven fibrous filter, no more than about 90 weight percent staple fibers are present, more typically no more than about 70 weight percent. Often, the remainder of the fibers are microfibers. Examples of webs that contain staple fibers are disclosed in U.S. Pat. No. 4,118,531 to Hauser.

Active particulate also may be included in electret webs for various purposes, including sorbent purposes, catalytic purposes, and others. U.S. Pat. No. 5,696,199 to Senkus et al., for example, describes various types of active particulate that may be suitable. Active particulate that has sorptive properties—such as activated carbon or alumina—may be included in the web to remove organic vapors during filtration operations. The active particulate may be present in the web at amounts up to about 95 volume percent. Examples of particle-loaded nonwoven webs are described, for example, in U.S. Pat. Nos. 3,971,373 to Braun, 4,100,324 to Anderson, and 4,429,001 to Kolpin et al.

Polymers that may be suitable for use in producing electret articles include thermoplastic organic nonconductive polymers. These polymers are generally capable of retaining a high quantity of trapped charge and are capable of being processed into fibers, such as through a melt-blowing apparatus or a spun-bonding apparatus. The term “organic” means that the backbone of the polymer comprises carbon atoms. Preferred polymers include polyolefins, such as polypropylene, poly-4-methyl-1-pentene, blends or copolymers containing one or more of these polymers, and combinations of these polymers. Other polymers may include polyethylene, other polyolefins, perfluoropolymers, polyvinylchlorides, polystyrenes, polycarbonates, polyethylene terephthalate, other polyesters, such as polylactide, and combinations of these polymers and optionally other nonconductive polymers may be used as polymeric fiber-forming material or for producing other electret articles.

The polymeric articles used to produce electret articles in connection with the present invention also may be extruded or otherwise formed to have multiple polymer components—see U.S. Pat. No. 4,729,371 to Krueger and Dyrud and U.S. Pat. Nos. 4,795,668, and 4,547,420 to Krueger and Meyer. The different polymer components may be arranged concentrically or longitudinally along the length of the fiber to create, for example, a bicomponent fiber. The fibers may be arranged to form a “macroscopically homogeneous” web, namely, a web that is made from fibers that each have the same general composition.

Fibers made from polymeric materials also may contain other suitable additives. Possible charge additives include thermally stable organic triazine compounds or oligomers, which compounds or oligomers contain at least one nitrogen atom in addition to those in the triazine ring—see U.S. Pat. Nos. 6,268,495, 5,976,208, 5,968,635, 5,919,847, and 5,908,598 to Rousseau et al. Another additive known to enhance electrets charged by jets of water is Chimassorb™ 944 LF (poly[[6-(1,1,3,3,-tetramethylbutyl) amino]-s-triazine-2,4-diyl][[(2,2,6,6-tetramethyl-4-piperidyl) imino] hexamethylene [(2,2,6,6-tetramethyl-4-piperidyl) imino]]), available from Ciba Specialty Chemicals, Inc. The additives may be N-substituted amino aromatic compounds, particularly tri-amino substituted compounds. One preferred trianilino triazine compound is 2,4,6-trianilino-p-(carbo-2′-ethylhexyl-1′-oxy)-1,3,5-triazine commercially available as “UVINUL T-150” from BASF, Ludwigshafen, Germany. Another charge additive is 2,4,6-tris-(octadecylamino)-triazine, also known as tristearyl melamine (“TSM”). Further examples of charge-enhancing additives are provided in U.S. Patent Application Ser. No. 61/058,029, and U.S. Patent Application Ser. No. 61/058,041. Typically, the additives are present in the polymeric article at about 0.1 to 5% by weight, more typically at about 0.25 to 2% by weight.

Other additives that may optionally be included in the antimicrobial electret webs described herein include light stabilizers, primary and secondary antioxidants, metal deactivators, hindered amines, hindered phenols, fatty acid metal salts, triester phosphites, phosphoric acid salts, and fluorine-containing compounds. See for example U.S. Pat. No. 7,390,351 to Leir et al., U.S. Pat. No. 5,057,710 to Nishiura et al.; and U.S. Pat. Nos. 4,652,282 and 4,789,504 to Ohmori et al.

The polymeric material that is used to produce an electret article may have a volume resistivity of 10¹⁴ ohm·cm or greater at room temperature. The volume resistivity may also be about 10¹⁶ ohm·cm or greater. Resistivity of the polymeric fiber-forming material can be measured according to standardized test ASTM D 257-93. The polymeric fiber-forming material used to make electret articles such as melt blown fibers also should be substantially free from components such as antistatic agents, that would increase the electrical conductivity or otherwise interfere with the ability of the electret article to accept and hold electrostatic charges.

Electrets that comprise (e.g. nonwoven) polymeric fibrous webs for respiratory filters typically have a “basis weight” of about 2 to 500 grams per square meter (g/m²), more typically about 20 to 150 g/m². The basis weight is the mass per unit area of filter web. The thickness of such nonwoven polymeric fibrous web is typically about 0.25 to 20 millimeters (mm), more preferably about 0.5 to 2 mm. Multiple layers of fibrous electret webs are commonly used in filter elements. One or more of such layers comprises a combination of antimicrobial and electret properties as described herein. The solidity of the fibrous electret web typically is about 1 to 25%, more typically about 3 to 10%. Solidity is a unitless parameter that defines the solids fraction in the article. The inventive article can contain a generally uniform charge distribution throughout a charged nonwoven fibrous web, without substantial regard to basis weight, thickness, or solidity.

Non-fibrous electret web articles that are used for filtration purposes may take the form of a shaped film, a microstructured surface, or a multitude of microstructured channels. Examples of non-fibrous electret articles are disclosed in U.S. Pat. Nos. 6,752,889 to Insley et al., 6,280,824 to Insley et al., 4,016,375 to Van Turnout, and 2,204,705 to Rutherford.

The electret charge can be imparted to the (e.g. nonwoven) web articles using various known techniques such as hydrocharging, corona charging, and combinations thereof. Unlike an electrostatic charge that dissipates shortly thereafter (such as can be created as a result of friction), the electret charge of the (e.g. nonwoven) web articles is a quasi-permanent electric charge that is substantially maintained for the intended product life of the article. Hence, sufficient charge is evident at the time of use as well as at least 6 months or 12 months after manufacturing.

To verify that a particular filter medium is electrostatically charged in nature, one may examine its performance after exposure to ionizing x-ray radiation. As described in the literature (Air Filtration by R. C. Brown (Pergamon Press, 1993 and “Application of Cavity Theory to the Discharge of Electrostatic Dust Filters by x-Rays”, A. J. WAKER and R. C. BROWN, Applied Radiation and Isotopes, Vol. 39, No. 7, pp. 677-684, 1988), if an electrostatically charged filter is exposed to x-rays, the penetration of an aerosol through the filter will be greater after exposure than before exposure, because the ions produced by the x-rays in the gas cavities between the fibers will have neutralized some of the electric charge. Thus, a plot of penetration against cumulative x-ray exposure can be obtained which shows a steady increase up to a constant level after which further irradiation causes no change. At this point all of the charge has been removed from the filter.

A % Penetration Ratio can be calculated according to the following equation: % Penetration Ratio=(% DOP Penetration after 40 min of x-ray exposure−Initial % DOP Penetration)/(% DOP Penetration after 40 min of x-ray exposure)×100, when tested according to the Filtration Performance Test Method, as described in the forthcoming examples. In order for the web to have sufficient charge for use as a filter, the % Penetration Ratio is typically at least 50%. As the % Penetration Ratio increase, the filtration performance of the web also increases. In some embodiments, the % Penetration Ratio is at least 55%, 60%, or 70%. In preferred embodiments, the % Penetration Ratio is at least 75% or 80%. In some embodiments, the unitary web exhibits a % Penetration Ratio of at least 85%, at least, or at least 95%.

The initial Quality Factor (prior to exposure to x-rays) is typically at least 0.3 and preferably at least 0.4 or 0.5 for a face velocity of 6.9 cm/s when tested according to the Filtration Performance Test Method, as described in the forthcoming examples. More preferably, the initial Quality Factor is at least 0.6 or 0.7. In some embodiments, the initial Quality Factor is at least 0.8, at least 0.90, at least 1.0, or even greater than 1.0. The Quality Factor after 40 minutes exposure to x-rays is typically at least 50% less than the initial Quality Factor. In preferred embodiments, the initial Quality Factor is at least 0.5 or greater and the Quality Factor after 40 minutes exposure to x-rays is less than 0.15.

In some embodiments, Thermally Stimulated Discharge Current (TSDC) testing can also be used to characterize the charge of the web. In some embodiments, such as when the web is charged by corona charging alone or corona charging in combination with hydrocharging, the (e.g. nonwoven) web has a charge density of at least 0.5 microcolombs per meter squared (μC/m²) when tested according to the TSDC Test Procedure 1, as described in the forthcoming examples.

In other embodiments, such as when the web is charged by hydrocharging alone or corona in combination with hydrocharging, the (e.g. nonwoven) web has a charge density of at least 1.0 microcolombs per meter squared (μC/m²) when tested according to the TSDC Test Procedure 2, as described in the forthcoming examples.

Hydrocharging may be carried out by contacting the web with an aqueous liquid sufficient to provide the web with filtration enhancing electret charge. The aqueous liquid contact may be achieved by spraying, soaking, condensing, etc., the aqueous liquid on the polymeric article to be charged. The article may be dried actively (with a vacuum or heat) or passively (hang drying) or combinations thereof. When the antimicrobial agent is not rendered inactive by the charging process, such as in the case of employing a (e.g. sparingly) soluble silver-containing compound, the antimicrobial agent can be added to the aqueous hydrocharging liquid.

Hydrocharging methods deposit both positive and negative charge onto the fibers such that the positive and negative charge is randomly dispersed throughout the web. Random charge dispersal tends to produce an unpolarized web. Thus, a nonwoven fibrous electret web produced by charging with a polar liquid like water may be substantially unpolarized in a plane normal to the plane of the web. A web, formed from fibers charged solely using hydrocharging, typically has unpolarized trapped charge throughout the volume of the web.

Various hydrocharging apparatus are known including for example the apparatus described in U.S. Pat. Nos. 5,496,507, 6,119,691, 6,375,886, and 6,783,574 to Angadjivand et al., U.S. Pat. No. 6,406,657 to Eitzman et al., and U.S. Pat. No. 6,743,464 to Insley et al.

The pH and conductivity of the aqueous hydrocharging liquid can be selected based on the zeta potential of the article as described in U.S. patent application Ser. No. 12/131,770, filed Jun. 2, 2008; incorporated herein by reference. Hence, the electret article can be made by a method comprising (a) providing a polymeric article to be charged; and (b) contacting the polymeric article to be charged with an aqueous liquid that has a pH and conductivity as follows: (i) if the article has a zeta potential of less than −7.5 millivolts (mV), then the contacting water has a conductivity of about 5 to 9,000 microSiemens per centimeter (microS/cm) and a pH greater than 7; and (ii) if the article has a zeta potential of greater than −7.5 mV, then the contacting water has a conductivity of about 5 to 5,500 microSiemens per centimeter (microS/cm) and a pH of 7 or less.

In some embodiments, the pH of the contacting hydrocharging aqueous liquid can be selected based on the pH of the antimicrobial treatment solution, or vice-versa. For example, acidic antimicrobial treatment solutions such as those containing silver sulfate, having a pH less than 7 are preferably employed with acidic hydrocharging aqueous liquid, also having a pH less than 7. Similarly, basic antimicrobial treatment solutions such as those containing silver oxide or rose bengal dye, having a pH greater than 7 are preferably employed with basic hydrocharging aqueous liquid.

Corona charging may be used alone or as a pretreatment or post-treatment in combination with hydrocharging.

After charging the electret properties of the web can be characterized based on various criteria and test methods.

In practical use, there may be considerable time lapse between the time the electret filter webs are charged and when they are used. This time encompasses the time required for shipping, storage, etc and may involve a variety of temperature conditions. It is desirable that charge imparted to the web be retained.

To model these considerations, a variety of filtration testing and accelerated aging testing protocols have been developed. These tests include measurement of the aerosol penetration of the filter web using a standard challenge aerosol such as dioctylphthalate (DOP), which is usually presented as percent of aerosol penetration through the filter web (% Pen) and measurement of the pressure drop across the filter web (ΔP), the details of which are described in the test method set forth in the examples. From these two measurements, a quantity known as the quality factor (QF) may be calculated by the following formula:

QF=−ln(% Pen/100)/ΔP,

where ln stands for the natural logarithm. A higher QF value indicates better filtration performance and decreased QF values effectively correlate with decreased filtration performance. The quality factor of the as generated webs without exposure to other environments is typically designated as “Q₀” the Initial Quality Factor.

The Q₀ of the antimicrobial electret webs described herein is typically at least 0.6, 0.7, 0.8, 0.9, or 1.0 for a face velocity of 6.9 cm/s. The antimicrobial agent preferably does not substantially reduce the initial electret properties. Hence, the antimicrobial electret webs described herein preferably have a Q₀ value of the at least 90%, 95%, or 100% of the Q₀ value of the same (non-antimicrobial web). In some embodiments, the presence of the antimicrobial agent enhances the electret properties of the web. Hence, the Q₀ value of the antimicrobial electret webs is (e.g. 5 to 10%) greater than the Q₀ value of the same (non-antimicrobial web).

In order to determine the stability of the filtration performance, accelerated aging can be tested by comparing the initial quality factor of charged BMF webs with its quality factor after storage at different temperatures for different periods of time.

In one test, the webs are stored for 72 hours at 71° C. in air. This quality factor after aging at this condition is typically designated as “Q₃”. The charge retention is calculated by the following equation:

% Charge Retention=Q₃(after aging for 72 hours at 71° C.)/Q₀(initial)×100%.

In some embodiments, the % Charge Retention is at least 75%, 80%, 85%, 90% or greater. In other embodiments the charge retention is 91%, 93%, 95% or greater, or even 100%.

In addition to the web exhibiting any one or combination of electret properties just described, the web also exhibits antimicrobial properties.

A variety of bacteria are growth inhibited by the antimicrobial electret web described herein. These include, but are not limited to gram positive pathogens such as Staphylococcus aureus and gram negative pathogens such as Pseudomonas aeruginosa.

Various antimicrobial agents can be utilized to impart antimicrobial properties to the web, provided that the antimicrobial agent is not a quaternary amine or the like that dissipates the charge.

The concentration of antimicrobial agent on the web can vary depending on the efficacy of the selected antimicrobial agent(s). In some embodiments, the (e.g. unitary) web comprises as little as 0.01, 0.05 or 0.1 mg/cm². Generally the web comprise no more antimicrobial agent than necessary to obtain the desired antimicrobial properties. This is typically obtained at concentration no greater than about 1 mg/cm².

In some embodiments, the antimicrobial agent comprises a metal oxide or metal salt that provides antimicrobial properties by release of positively charge metal ions.

One exemplary class of such antimicrobial agents is silver-based compounds. As described for example in US2006/0035039, silver is well known for imparting antimicrobial activity to a surface with minimal risk of developing bacterial resistance. Silver ions are broad spectrum antimicrobials that kill microorganisms without significant negative effects on human cells. In contrast to antibiotics, silver ions are rarely associated with microbial resistance. As such, the systematic use of silver-containing compounds generally does not generate concerns in the medical field over antibiotic-resistant bacteria. The antimicrobial activity of silver is believed to be due to free silver ions or radicals, where the silver ions kill microbes by blocking the cell respiration pathway (by attaching to the cell DNA and preventing replication) and by disruption of the cell membrane.

In some embodiments, the antimicrobial agent is preferably a sparingly soluble silver-containing (SSSC) compound. As used herein, the terms “sparingly soluble silver-containing compound” and “SSSC compound” are defined as a silver-containing compound that, without the assistance of a solubilizer, is only soluble in water up to about 10.0 grams per liter of water. In some embodiments, the SSSC compounds, i.e. without the assistance of a solubilizer, are only soluble in water up to about 0.1 grams per liter of water. As such, SSSC compounds are difficult to directly disperse or dissolve in solutions. This renders the SSSC compounds excellent sources for slow and sustained release of silver ions. The concentration of released silver ions is relatively small, and silver does not leach out of the treated web when contacted with other substrates such as human skin. Silver compounds such as sparingly soluble silver-containing (SSSC) compounds, as described herein, have been found not to detrimentally affect the charge properties of the web.

Examples of suitable SSSC compounds include silver oxide, silver sulfate, silver acetate, silver chloride, silver lactate, silver phosphate, silver stearate, silver thiocyanate, silver proteinate, silver carbonate, silver sulfadiazine, silver alginate, and combinations thereof. Examples of particularly suitable SSSC compounds include silver oxides, silver carbonates, and silver acetates. Examples of suitable concentrations of the SSSC compound in the fluid solution range from about 0.1% to about 15.0% by weight, based on the total weight of the fluid solution. Examples of particularly suitable concentrations of the SSSC compound in the fluid solution range from about 1.0% to about 5.0% by weight, based on the total weight of the fluid solution.

To accommodate for the low solubility of the SSSC compound in aqueous solvents, the SSSC compound may be mixed with a solubilizer in the aqueous solvent. Preferably, the fluid solution is stable over a period of time, such as one month, without significant precipitation of the SSSC compound from the fluid solution. This allows the fluid solution to be stored prior to use.

In one embodiment, the solubilizer may be an ammonium-containing compound. The ammonium-containing compound complexes with the SSSC compound to substantially dissolve the SSSC compound in the aqueous solvent. Depending on the SSSC compound used, the SSSC compound may readily dissolve in the aqueous solvent at room temperature when mixed with the ammonium-containing compound. If not, mechanical action such as stirring over time and/or heat may be required to aid the dissolution.

Examples of suitable ammonium-containing compounds include ammonium salts such as ammonium pentaborate, ammonium acetate, ammonium carbonate, ammonium peroxyborate, ammonium tertraborate, triammonium citrate, ammonium carbamate, ammonium bicarbonate, ammonium malate, ammonium nitrate, ammonium nitrite, ammonium succinate, ammonium sulfate, ammonium tartarate, and combinations thereof. Examples of suitable concentrations of the ammonium-containing compound in the fluid solution range from about 1.0% to about 25% by weight, based on the total weight of the fluid solution. The amount of the ammonium-containing compounds in the fluid solution is typically selected as the minimum needed to dissolve the SSSC compound used.

An example of particularly suitable solubilizer containing SSSC material for the fluid solution of the present invention includes silver oxide, ammonium carbonate, and an aqueous solvent, such as water. While not wishing to be bound by theory, it is believed that the silver oxide and the ammonium carbonate complex to dissolve the silver oxide in the aqueous solvent. The complexing creates a silver carbonate compound and ammonia. The fluid solution is then applied to an article, such as a non-woven polypropylene, by spraying or dip coating.

As the fluid solution dries and the ammonia evaporates, silver oxide is reformed on the article surface. This is believed to be due to the oxidation and degradation of the silver carbonate compound into silver oxide and carbon dioxide while the fluid solution dries. The carbon dioxide evaporates upon formation. The reformation of the silver oxide is observable by a color change. Prior to drying, the fluid solution is colorless. However, after drying, the residual portion of the fluid solution turns dark brown, which is a typical characteristic of silver oxide.

In regard to silver oxide, a variety of valence states of the silver oxide may be used (e.g., where the oxidation state is silver (II) oxide or silver (III) oxide). The valence state of the silver oxide on the article surface may be determined by depositing a silver oxide of a given valence state (e.g., Ag₂O, AgO, Ag₂O₃, Ag₂O₄). Alternatively, the valence state of the silver oxide may be increased by including an oxidizing agent to the fluid solution of the present invention, or applying an oxidizing agent to the article surface after applying the fluid solution to the article surface. Examples of suitable oxidizing agents include hydrogen peroxide, alkali metal persulfates, permanganates, hypochlorites, perchlorates, nitric acid, and combinations thereof. An example of a suitable alkali metal persulfate includes sodium persulfate as discussed in Antelman, U.S. Pat. No. 6,436,420, which is incorporated by reference in its entirety.

Other particularly suitable silver compositions include silver sulfate in water. The silver sulfate coating solution is prepared by mixing silver sulfate and distilled water. The silver sulfate coating solution can have a range of concentrations up to a water solubility of about 0.6% at room temperature without the addition of a solubilizer. Optionally, higher concentrations of silver sulfate can be obtained by dissolving silver sulfate in hot water or by increasing the pH of the water by incorporating ammonia for example. Optionally sulfates in other forms may be added, such as sodium sulfate.

In other embodiments, the antimicrobial agent is a photosensitive chemical that absorbs light and causes the formation of reactive oxygen species, such as singlet oxygen radical. Without intending to be bound by theory, such singlet oxygen radicals are believed to form adjacent to the surface treatment and thus are physically separated from the charged web. This alone or in combination with the short duration of time (i.e. seconds) such singlet oxygen radicals are present before reacting are surmised to be the reason such antimicrobial agents do not negatively effect the charge properties.

Suitable photosensitizers for the present invention are those that display both light and dark microbicidal activity. As used herein, “light activity” refers to limiting the presence of microorganisms when the photosensitizer is exposed to light, such as that from a directed light source or from ambient light. As used herein, “dark activity” refers to limiting the presence of microorganisms when the photosensitizer is in the dark (i.e., when there is substantially no visible light present).

Examples of classes of such photosensitizers include the xanthene dyes, the triphenylmethine dyes, and the oxazine dyes. Although the scope of the polymer compositions of the present invention is not so limited, preferably, the photosensitizer is a xanthene dye of the following formula:

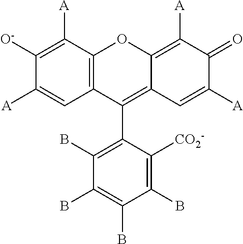

wherein the negative electric charges are balanced independently with the cations Na⁺, K⁺, Li⁺, H⁺ or substituted ammonium; each A independently represents hydrogen, chlorine. bromine, or iodine; and each B independently represents hydrogen, chlorine, bromine, or iodine.

The xanthene photosenisitizers of the present invention can be purchased from a chemical supplier or prepared according to methods known to those skilled in the art of organic synthesis. Examples of xanthene photosensitizers that can be purchased include rose bengal, where A=I and B=Cl in the formula above; erythrosin, where A=I and B=H; phloxin B, where A=Br and B=Cl; eosin yellowish, where A=Br and B=H; and fluorescein, where A=H and B=H.

Xanthene photosensitizers such as rose bengal are known to be effective in microbial load reduction of 90 to 99% for S. aureus (gram positive), but not particularly effective in microbial load reduction of Ps. aeruginosa (gram negative) pathogens. When the antimicrobial electret web employs a photosensitive antimicrobial agent that forms a reactive (e.g. singlet) oxygen species, the antimicrobial electret web may also inactivate both DNA and RNA viruses as described in U.S. Pat. No. 6,420,455; incorporated herein by reference.

In some preferred embodiments, a combination of at least one sparingly soluble silver-containing (SSSC) compound is employed in combination with at least one photosensitive antimicrobial agent that forms reactive oxygen species, such as a xanthene photo sensitizer.

Other suitable antimicrobial agents include biguanide compounds. Examples of such biguanide compounds include, but are not limited to, chlorhexidine free base, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine diiodobutyrate, chlorhexidine di-n-valerate, chlorhexidine dicaproate, chlorhexidine malonate, chlorhexidine succinate, chlorhexidine malate, chlorhexidine tartrate, chlorhexidine gluconate (“CHG”), techlorhexidine dimonoglycolate, chlorhexidine monodiglycolate, chlorhexidine dilactate, chlorhexidine di-.alpha.-hydroxyisobutyrate, chlorhexidine diglucoheptonate, chlorhexidine diisothionate, chlorhexidine dibenzoate, chlorhexidine dicinnamate, chlorhexidine dimandelate, chlorhexidine di-isophthalate, chlorhexidine di-2-hydroxynapthoate, chlorhexidine embonate, polyhexamethylene biguanide (“PHMB”), and alexidine (N,N″-bis(2-ethylhexyl)-3,12-diimino-2,4,11,13-tetraazatetradecanediimid-amine; 1,1′-hexamethyl-enebis [5-(2-ethylhexyl)biguanide]). One preferred biguanide compound is a polyalkyl biguanide compound such as polyhexamethylene biguanide (“PHMB”).

The antimicrobial agent is typically applied to a preformed (non-antimicrobial web) as a surface treatment. By “surface treatments” it is meant that the antimicrobial agent is present on the exterior surface of the polymer fibers of the web, rather than combined with the polymeric material from which the web is formed.

The antimicrobial treatment solution may be applied to the web using either non-contact or contact based deposition techniques. Suitable non-contact deposition techniques for use with the present invention include inkjet printing, spray atomization deposition, electrostatic deposition, micro dispensing, and mesoscale deposition. Particularly suitable non-contact deposition techniques include inkjet printing and spray atomization deposition. Contact based deposition methods include coating techniques such as gravure coating, curtain coating, die coating, knife coating, or roll coating. A preferred contact based coating method is gravure coating.

Alternatively, the antimicrobial solution can be coated on a substrate such as by passing the web through the antimicrobial treatment solution. The coated substrate is dried to drive off the volatile components, such as water and organic solvents (e.g., methanol, ethanol, isopropanol, acetone, or other organic solvents that are miscible with water). Drying can be accomplished at room temperature or by heating the coated substrate.

For embodiments where the antimicrobial agent is a photosensitive antimicrobial agent that forms reactive oxygen species, such as rose bengal, it has been found that hydrocharging the web after the antimicrobial surface treatment is applied to the web can diminishes the efficacy of the antimicrobial agent. Hence, it may be preferred to charge the web before application of the antimicrobial surface treatment.

The antimicrobial agents, such as the (e.g. sparingly soluble) silver compounds, can reduce pathogenic contamination when pathogens come is contact with the surface. In some embodiments, such when the web comprises a photosensitive antimicrobial agent that forms reactive oxygen species, the electret web can also reduce pathogens that do not necessary contact the web, but pass between the surface treated fibers of the web.

Examples of suitable levels of antimicrobial activity include microbial load reductions of at least about 90% for at least one of S. aureus (gram positive) and Ps. aeruginosa (gram negative) pathogens. Examples of even more suitable levels of antimicrobial activity include microbial load reductions of at least about 99% for at least one of S. aureus (gram positive) and Ps. aeruginosa (gram negative) pathogens. Examples of particularly suitable levels of antimicrobial activity include microbial load reductions of at least about 90% for both of S. aureus (gram positive) and Ps. aeruginosa (gram negative) pathogens. Finally, examples of even more particularly suitable levels of antimicrobial activity include microbial load reductions of at least about 99% for both of S. aureus (gram positive) and Ps. aeruginosa (gram negative) pathogens. The “microbial load reductions” herein refer to microbial load reductions obtained pursuant to AATCC Method 100-2004 (tested as described in the examples).

Electrets described herein are suitable for various uses such as electrostatic elements in electro-acoustic devices such as microphones, headphones and speakers, dust particle control devices in, e.g., high voltage electrostatic generators, electrostatic recorders, respirators (e.g., prefilters, canisters and replaceable cartridges), heating, ventilation, air conditioning, and face masks.

The antimicrobial electret articles may be used as filters in filtering masks or respirators that are adapted to cover at least the nose and mouth of a wearer.

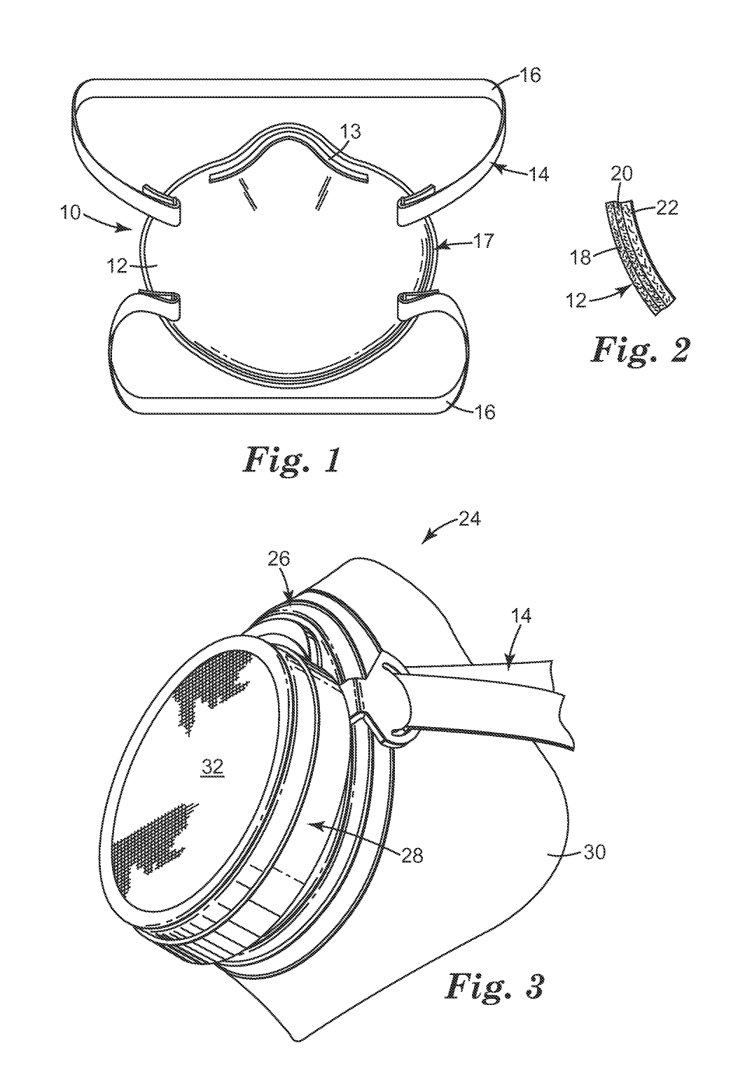

FIG. 1 illustrates an example of a filtering face mask 10 that may be constructed to contain an electrically-charged nonwoven web that is produced according to the present invention. The generally cup-shaped body portion 12 may be molded into a shape that fits over the nose and mouth of the wearer. The body portion 12 is porous so that inhaled air can pass through it. The electret filter medium is disposed in the mask body 12 (typically over substantially the whole surface area) to remove contaminants from the inhaled air. A conformable nose clip 13 may be placed on the mask body to assist in maintaining a snug fit over the wearer's nose. The nose clip can be an “M-shaped” clip. See for example U.S. Pat. No. 5,558,089. A strap or harness system 14 may be provided to support the mask body 12 on the wearer's face. Although a dual strap system is illustrated in FIG. 1, the harness 14 may employ only one strap 16, and it may come in a variety of other configurations. An exhalation valve can be mounted to the mask body to rapidly purge exhaled air from the mask interior.

FIG. 2 illustrates an example of a cross-section of a mask body 12. Mask body 12 may have a plurality of layers, as indicated by numerals 18, 20, and 22. The electret filter media may be supported by other layers, such as shaping layers that are made from thermally bonded fibers, such as bicomponent fibers that have an outer thermoplastic component that enables the fibers to bond to other fibers at points of fiber intersection. Layer 18 can be an outer shaping layer, layer 20 may be a filtration layer, and layer 22 may be an inner shaping layer. Shaping layers 18 and 22 support filtration layer 20 and provide shape to mask body 12. Although the term “shaping layers” is used in this description, shaping layers also have other functions, which in the case of an outermost layer may even be a primary function, such as protection of the filtration layer and prefiltration of a gaseous stream. Although the illustrated mask body shown in FIGS. 1 and 2 has a generally round, cup-shaped configuration, the mask body may have other shapes. Further, the mask body may comprise an inner and/or outer cover web to provide a smooth and comfortable contact with the wearer's face and/or to preclude fibers from the shaping and filtration layers from coming loose from the mask body. The respiratory mask also may have a flat-folded mask body (rather than a molded mask body).

FIG. 3 illustrates another respirator 24 that may use the inventive electret articles as a filter. Respirator 24 includes an elastomeric mask body 26 that has a filter cartridge 28 secured to it. Mask body 26 typically includes an elastomeric face piece 30 that conformably fits over the nose and mouth of a person. The filter cartridge 28 may contain the electret filter media made according to the present invention to capture contaminants before they are inhaled by the wearer. The filter element may include the polymeric electret filter article by itself or in conjunction with a gaseous filter such as an activated carbon bed. A porous cover or screen 32 may be provided on the filter cartridge to protect the external surface of the filter element.

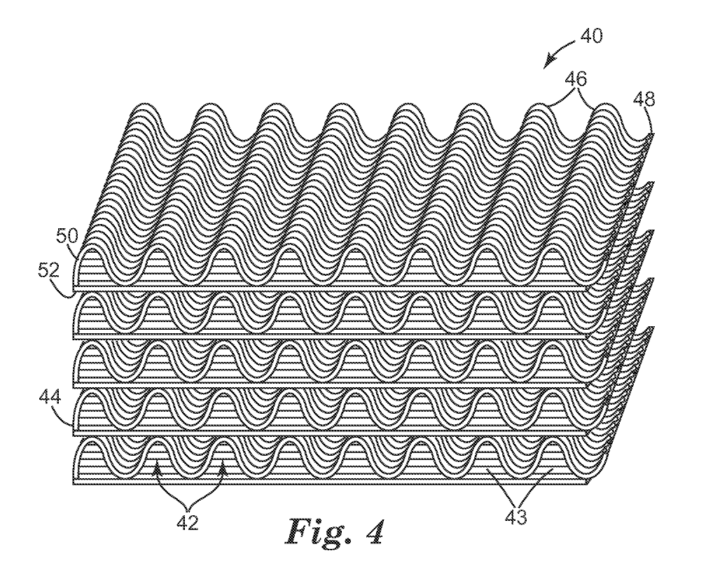

FIG. 4 shows a perspective view of a filtration media array 40. The structure of array 40 may comprise multiple flow channels 42 that have inlets 43 on a first side 44 of the array 40 and have outlets 46 on a second side of the array 48. The flow channels may be defined by a corrugated or microstructured layer 50 and a cap layer 52. The contoured layer 50 may be joined to the cap layer 52 at one or more peaks or valleys. By stacking multiple layers of structured and planar members, a microchanneled arrangement may be achieved. The flow channels tend to have a high aspect ratio, and the film layers are preferably electrically charged to provide the article 40 with good capture efficiency. The pressure drop across the array 40 from first side 44 to second side 48 is negligible.

### EXAMPLES

### Meltblown Extrusion Process:

For each Example, a polypropylene blown microfiber (BMF) nonwoven web was prepared from polypropylene resin from TOTAL PETROCHEMICALS under the trade designation “PP3960”. The resin was extruded as described in Van A. Wente, Superfine Thermoplastic Fibers, 48 Indust. Engn. Chem., 1342-46 and Naval Research Laboratory Report 111437 (Apr. 15, 1954). The extrusion temperature ranged from about 250° C.-300° C. and the extruder was a BRABENDER conical twin-screw extruder (commercially available from Brabender Instruments, Inc.) operating at a rate of about 2.5 to 3 kg/hr (5-7 lb/hr). The die was 25.4 cm (10 in) wide with 10 holes per centimeter (25 holes per inch). The (BMF) webs formed had basis weights of about 50-60 g/m², effective fiber diameters of about 6.5-9.5 micrometers, and thicknesses of about 0.75-2 millimeters. In some examples a charging additive was dry blended with the polypropylene pellets prior to extrusion. The charging additives are described as follows:

| Trade Designation | Chemical Description |
|---|---|
| Uvinul T-150 | 2,4,6-trianilino-p-(carbo-2′-ethylhexyl- |
| | 1′-oxy)-1,3,5-triazine |
| | commercially available as |
| | UVINUL T-150 from BASF, |
| | Ludwigshafen, Germany. |
| TSM | 2,4,6-tris-[octadecylamino]- |
| | triazine, also known as tristearyl |
| | melamine. |

### Electret Charging Process:

The BMF webs were charged by one of three electret charging methods: hydrocharging, corona charging, or corona pretreatment and hydrocharging.

Charging Method 1—Hydrocharging: A fine spray of high purity water having a conductivity of less than 5 microS/cm was continuously generated from a nozzle operating at a pressure of 896 kiloPascals (130 psig) and a flow rate of approximately 1.4 liters/minute. The BMF web was conveyed by a porous belt through the water spray at a speed of approximately 10 centimeters/second while a vacuum simultaneously drew the water through the web from below. Each BMF web was run through the hydrocharger twice (sequentially once on each side) and then allowed to dry completely overnight prior to filter testing.
Charging Method 2—Corona Charging: The BMF web was charged by DC corona discharge. The corona charging was accomplished by passing the web on a grounded surface under a corona brush source with a corona current of about 0.01 milliamp per centimeter of discharge source length at a rate of about 3 centimeters per second. The corona source was about 3.5 centimeters above the grounded surface on which the web was carried. The corona source was driven by a positive DC voltage.

### Charging Method 3—Corona Pre-Treatment and Hydrocharging:

The BMF web was pretreated by DC corona discharge as described in Charging Method 2 and then charged by hydrocharging as described in Charging Method 1.

### Antimicrobial Treatment Solutions:

Treatment Solution 1: A fluid solution of 3 wt % silver (II) oxide and 6 wt % ammonium carbonate in water.
Treatment Solution 2: A fluid solution of 0.5 wt % silver sulfate in water.
Treatment Solution 3: A fluid solution of 12 wt % ammonium hydroxide (40 wt % of a 29 wt % ammonium hydroxide solution) and 0.1 wt % rose bengal (4,5,6,7-Tetrachloro-3′,6′-dihydroxy-2′,4′,5′,7′-tetraiodo-3H-spiro[isobenzofuran-1,9′-xanthen]-3-one) in water.
Treatment Solution 4: An aqueous solution of 1.0 wt % of the quaternary amine obtained from Lonza, Inc., Allendale, N.J. under the trade designation “Bardac 208M”.
Treatment Solution 5: A fluid solution of 2.0 wt % silver nitrate in water.
Treatment Solution 6: An aqueous solution of 1.0 wt % of poly (hexamethylene biguanide) hydrochloride (PHMB) obtained from Arch Chemicals, Inc., Norwolk, Conn., under the trade designation “Vantocil 100”.

### Antimicrobial Treatment Methods:

The various antimicrobial treatment solutions described above were applied to the BMF webs as described below.
Antimicrobial Treatment Method 1: The antimicrobial treatment solution was inkjet printed at 100% surface coverage onto the BMF surface with a XAAR XJ128-200 Printhead. The printhead was peizoelectrically driven at 1.25 kHz and 35 V, with a printing resolution of 300×300 dpi. This generated drops of the fluid solution with nominal volumes of about 70 pL. The coated BMF web surface was then air dried 15 minutes.
Antimicrobial Treatment Method 2: The antimicrobial treatment solution was poured into aluminum trays. The nonwoven web was immersed into the treatment solution by hand on both its top and bottom sides. It was removed from the solution and hung to dry until solution no longer dripped off of the web. Then it was oven dried. For silver sulfate solutions, the oven was set to 120° C., and the web was dried for 10 minutes. For rose bengal solutions, the oven was set to 70° C., and the fabric web was dried for 15 minutes. After oven drying, the web was allowed to dry in air overnight.

### Antimicrobial Testing Methods:

AATCC Method 100—One method of measuring antimicrobial activity of a porous substrate is the Standard AATCC Method 100-2004 (American Association of Textile Chemists and Colorists Standard test method for the Assessment of Antibacterial Finishes on Textile Materials). AATCC Method requires inoculating 1 mL of bacteria culture onto the substrate and incubating the samples for 24 hours after inoculation.

Samples were tested in accordance with the AATCC Method 100 using D/E Neutralizing broth and Petrifilm™ Aerobic Count Plates for enumeration. Samples were not sterilized prior to testing. Each sample was inoculated with 1 ml of a suspension containing approximately 1-2×10⁵ colony forming units (cfu)/ml of an appropriate test organism. Samples were incubated at 28° C. for 24 hours. After 24 hours incubation, each sample was placed in a sterile stomacher bag and 100 ml of D/E Neutralizing Broth was added. The sample was processed for two minutes in a Seward Model 400 Stomacher. Serial dilutions of 10⁰, 10¹ and 10² and aerobic plate count using 3M Petrifilm™ Aerobic Count (AC) were performed. Total colony forming units per sample were recorded after 48 hours of Petrifilm™ incubation at 35° C.±1° C. The percent reduction in microbial numbers was calculated. Samples were tested against either Staphylococcus aureus (ATCC 6538) a gram positive bacteria or Pseudomonas aeruginosa (ATCC 9027) a gram negative bacteria or both.

### Filtration Performance Test Method:

The filtration performance of the nonwoven blown microfiber (BMF) webs were evaluated using an Automated Filter Tester AFT Model 8127 (available from TSI, Inc., St. Paul, Minn.) using dioctylphthalate (DOP) as the challenge aerosol. The DOP aerosol is nominally a monodisperse 0.3 micrometer mass median diameter having an upstream concentration of 70-120 mg/m³. The aerosol was forced through a sample of filter media at a face velocity of 6.9 cm/s with the aerosol ionizer turned off. The total testing time was 23 seconds (rise time of 15 seconds, sample time of 4 seconds, and purge time of 4 seconds). The concentration of DOP aerosol was measured by light scattering both upstream and downstream of the filter media using calibrated photometers. The DOP % Penetration (% Pen) is defined as: % Pen=100×(DOP concentration downstream/DOP concentration upstream). Simultaneously with % Pen, the pressure drop (ΔP (mm of H₂O)) across the filter is measured by the instrument. For each material, 6 separate measurements were made at different locations on the BMF web and the results were averaged. The % Pen and ΔP were used to calculate a Quality Factor (QF) by the following formula:

QF=−ln(% Pen/100)/ΔP,

where ln stands for the natural logarithm. A higher QF value indicates better filtration performance and decreased QF values effectively correlate with decreased filtration performance

### Initial Filtration Performance:

Each of the charged samples was tested in its quiescent state for % Pen and ΔP, and the QF was calculated as described above. These results are reported below as Initial % Pen, Initial ΔP and Initial QF “Q₀”.

### Accelerated Aging Filtration Performance:

In order to determine the stability of the filtration performance, accelerated aging was tested by comparing the initial QF of charged BMF webs with its QF after storage at an elevated temperature for a specified period of time. The webs are stored for 72 hours (3 days) at 71° C. in air. This quality factor after aging at this condition is typically designated as “Q₃”. The % Charge Retention is calculated by the following equation:

% Charge Retention=Q₃(after aging for 72 hours at 71° C.)/Q₀(initial)×100%

### Thermally Stimulated Discharge Current Measurements (TSDC):

The effective charge density of samples of charged fibrous filter media was determined by integrating the absolute discharge current measured using a Solomat TSC/RMA Model 91000 Spectrometer with a pivot electrode, distributed by TherMold Partners, L. P., Stamford, Conn. Samples were cut and secured between a lower fixed electrode and an upper spring-loaded electrode in the Solomat TSC/RMA. The area of the upper electrode is 0.38 cm² (about 7 mm in diameter). In the TSC/RMA instrument, a thermometer is disposed adjacent to, but not touching the sample. The samples should be optically dense, such that there are no holes visible through the sample. Since the electrode is about 7 mm in diameter, the samples were cut larger than the 7 mm in diameter. To ensure good electrical contact with the electrodes, the samples were compressed in thickness by a factor of about 10. Air and moisture were evacuated from the sample cell through a series of flushing stages and the cell was back-filled with helium to approximately 1100 mbar. The sample cell was cooled by liquid nitrogen as desired by the specific test protocol.

Current measurements were made while heating the sample at a controlled temperature ramp rate of 5° C./min up to 175° C. During such a thermally stimulated discharge, charges stored in the electret become mobile and are neutralized either at the electrodes or in the bulk sample by recombination with charges of opposite sign. This will generate an external current that shows a number of peaks when recorded as a function of temperature. The shape and location of these peaks depends on charge trapping energy levels and the physical location of the trapping sites. By integrating the current versus temperature plot, one can calculate an effective charge density (microC/m²). Specifically, the relationship between effective charge density and external discharge current is given by the equation below:

$$\frac{Q}{A} = \frac{1}{RA} {\int }_{Ta}^{Tb} I d T$$

where

Q=charge in microcoulombs
A=the electrode area in m²

R=the heating rate in ° C./sec

Tₐ and T_{b} define the temperature range of interest

and I=the measured current in amps.

To calculate the integral, we use a computer program based on the trapezoid rule for numerical integration:

$${\int }_{Ta}^{Tb} I d T = \frac{1}{2} {\sum }_{i = 1}^{n} ( {T}_{i + 1} - {T}_{i} ) ( {I}_{i + 1} + {I}_{i} )$$

where n=the number of data points between Tₐ and T_{b} with T₁=Tₐ and Tₙ=T_{b}.
Initial and final temperatures are entered into the program, and the integrated charge is returned. Positive and negative current peaks are considered separately, and the magnitude (absolute value) of the integrated charge from each peak is summed to determine the total effective charge on the sample. The total effective charge is then divided by the electrode area to obtain the effective charge density (microC/m²) in the temperature range of interest. For all samples considered Tₐ is 10° C. T_{b} is chosen to correspond with the average onset temperature of melting for polypropylene, which was set to 140° C. for all samples considered. In a TSDC measurement melting is usually characterized by a sudden rapid increase in the magnitude of the measured external discharge current which is observed for both charged and uncharged samples.
TSDC Testing Procedures: Two different protocols were used to determine to what extent the trapped electrostatic charge (electret) on the filter media is unpolarized in nature.
TSDC Test Procedure 1—Simple Depolarization: In the first test procedure the sample is cooled to 5° C. where it is equilibrated for 5 minutes and then heated at 5° C./min to 175° C. while the discharge current is measured. By integrating the discharge curve obtained in this test (as described above) one can calculate an effective charge density.
TSDC Test Procedure 2—Depolarization after Poling at 100° C.: In the second test procedure the sample is first heated to 100° C. where it is held while an electric field (2500 V/mm) is applied for 5 minutes across the electrodes to polarize trapped charge in the sample. Then it is cooled at 90° C./min to −50° C. where it is held for 5 minutes. Finally the sample is heated at 5° C./min to 175° C. while the external discharge current is measured. By integrating the TSC discharge curve obtained in this test one can calculate an effective charge density.

### X-Ray Discharge Test:

To discharge select pieces of filter media, a Baltograph 100/15 CP (Balteau Electric Corp., Stamford, Conn.) x-ray exposure system consisting of a constant potential end grounded generator rated at 100 KV at 10 mA with a beryllium window (0.75 mm inherent filtration) with an output of up to 960 Roentgen/min at 50 cm from the focal spot of 1.5 mm×1.5 mm was employed. The voltage was set to 80 KV with a corresponding current of 8 mA. A sample holder was set up at a maximum distance of 22.5 inch from the focal spot. This produced an exposure of about 580 Roentgen/min.

### Test Procedure:

A sample of the selected type of filter media tested as described above for its initial filtration performance (QF) before exposure to x-rays (time=0). Subsequently, the sample of filter media was exposed on each side to x-rays using the system described above, ensuring that the entire sample is exposed to the x-ray radiation. After x-ray exposure, the sample of filter media was tested again to measure its filter performance (QF). The procedure was repeated until the filter performance reached a plateau value, indicating all of the sample's electrostatic charge has been neutralized.

### Example Set #1

### Ag(II)O Antimicrobial Surface Treatment of Electret Filter Media

### Example Preparation:

Several 6 inch×8 inch pieces of the polypropylene melt blown microfiber nonwoven (BMF) web were cut and treated with Antimicrobial Treatment Solution #1 using Treatment Method #1 with the piezo-printer (XY Printer with Xaar XJ-128) as previously described. The Ag(II)O antimicrobial concentration of the dried web was 0.04 mg/cm².

The nonwoven webs were first charged by Charge Method #2 then by Charge Method #3 after antimicrobial treatment to form an antimicrobial electret filter.

The nonwoven webs were then tested for filtration performance as described above, and the results are reported in Table 1. For antimicrobial efficacy the webs were tested using P. aeruginosa. For each sample, there were two sets of duplicates or four total samples. An average was taken of these four samples and is reported in Table 1.

TABLE 1
Filtration and antimicrobial performance for Ag(II)O treated electrets

| | | | | | % Microbial |
|---|---|---|---|---|---|
| | | ΔP | % | | Load |
| | Sample Description | (mm H₂O) | Pen | Q₀ | Reduction |
| 1 | Charge method #2 then | 3.93 | 4.36 | 0.82 | 99.98 |
| | antimicrobial treatment | | | | |
| | then Charge Method #1 | | | | |

As depicted in Table 1, a combination of good filtration performance and good antimicrobial efficiency against the gram negative P. aeruginosa can be achieved with sparingly soluble silver-containing compounds such as Ag(II)O

### Example Set #2

### Ag₂SO₄ Antimicrobial Treatment of Electret Filter Media

Two polypropylene melt blown microfiber nonwoven (BMF) webs were prepared as described above using PP3960 resin from TOTAL PETROCHEMICALS. Each web contained 1 wt % of either Uvinul T-150 or TSM as a charging additive.

Several 8 inch×36 inch pieces of each BMF web were cut and treated with Antimicrobial Treatment Solution #2 (Ag₂SO₄) via Treatment Method #2. The webs containing Uvinul T-150 were charged by the Charging Method #2 (corona charging) followed by Charging Method #1 (hydrocharging) either before or after antimicrobial treatment whereas the webs containing TSM were charged by Charging Method #1 (hydrocharging) either before or after antimicrobial treatment to form antimicrobial electret filters. The charge additive and processing sequence of antimicrobial treatment and hydrocharging is described in Tables 2A and 2B. The Ag₂SO₄ concentration of the dried web was 0.06 mg/cm².

For each sequence of charging and antimicrobial treatment, 2 sets of specimens were prepared. One set was use to measure Q₀, and the second set was used to measure Q₃ by aging in an oven set at 71° C. for 3 days. The samples were then tested for filtration performance. For antimicrobial efficacy the webs were tested with bacteria cultures (gram negative P. aeruginosa, and gram positive S. Aureus using Antimicrobial Test AATCC Method 100. For each sample, there were two sets of duplicates or four total samples tested with each type of bacteria. An average was taken of these four samples and reported in Table 2B.

TABLE 2A
Filtration Performance for Ag₂SO₄ Treated Electrets

| | ΔP | | | ΔP | | | |
|---|---|---|---|---|---|---|---|
| | Initial | % | | Aged | % | | % |
| | (mm | Pen | | (mm | Pen | | Charge |
| Sample Description | H₂O) | Initial | Q₀ | H₂O) | Aged | Q₃ | Retention |
| 2-A: 1% TSM- | 2.38 | 1.95 | 1.66 | 2.22 | 3.66 | 1.55 | 93% |
| Hydrocharged then | | | | | | | |
| antimicrobial | | | | | | | |
| treatment | | | | | | | |
| 2-B: 1% TSM- | 2.37 | 0.62 | 2.17 | 2.28 | 2.31 | 1.67 | 77% |
| Antimicrobial | | | | | | | |
| treatment then | | | | | | | |
| Hydrocharged | | | | | | | |
| Control | 2.32 | 1.03 | 1.99 | 2.42 | 1.73 | 1.68 | 85% |
| 2-C: 1% TSM- | | | | | | | |
| Hydrocharged with | | | | | | | |
| No antimicrobial | | | | | | | |
| treatment | | | | | | | |
| 2-D: 1% Uvinul | 2.00 | 8.06 | 1.27 | 2.30 | 4.67 | 1.33 | 105% |
| T-150- | | | | | | | |
| Hydrocharged then | | | | | | | |
| antimicrobial | | | | | | | |
| treatment | | | | | | | |
| 2-E: 1% Uvinul T- | 2.08 | 12.83 | 0.99 | 2.02 | 14.88 | 0.95 | 96% |
| 150-Antimicrobial | | | | | | | |
| treatment then | | | | | | | |
| Hydrocharged | | | | | | | |
| Control | 2.12 | 3.18 | 1.65 | 2.08 | 3.98 | 1.56 | 95% |
| 2-F: 1% Uvinul | | | | | | | |
| T-150- | | | | | | | |
| Hydrocharged with | | | | | | | |
| No antimicrobial | | | | | | | |
| treatment | | | | | | | |

TABLE 2B
Antimicrobial Performance for Ag₂SO₄ Treated Electrets

| | | % | | |
|---|---|---|---|---|
| | | Microbial | | % Microbial |
| | | Load | | Load |
| | staph | Reduction | pseudomonas | Reduction |
| Sample | aureus | staph | aeruginosa | pseudomonas |
| Description | (CFU/ml) | aureus | (CFU/ml) | aeruginosa |
| 2-A: 1% TSM- | 5.94E+03 | 99.86 | 6.40E+03 | 99.987 |
| Hydrocharged then | | | | |
| antimicrobial | | | | |
| treatment | | | | |
| 2-B: 1% TSM- | Not | Not | 6.31E+03 | 99.987 |
| Antimicrobial | Available | Available | | |
| treatment then | | | | |
| Hydrocharged | | | | |
| Control | 4.13E+06 | — | 5.00E+07 | — |
| 2-C: 1% TSM- | | | | |
| Hydrocharged with | | | | |
| No antimicrobial | | | | |
| treatment | | | | |
| 2-D: 1% Uvinul T- | 1.56E+03 | 99.99 | 2.56E+02 | 99.999 |
| 150- | | | | |
| Hydrocharged then | | | | |
| antimicrobial | | | | |
| treatment | | | | |
| 2-E: 1% Uvinul T- | 1.56E+04 | 99.97 | 3.62E+03 | 99.997 |
| 150-Antimicrobial | | | | |
| treatment then | | | | |
| Hydrocharged | | | | |
| Control | 6.06E+07 | — | 1.25E+08 | — |
| 2-F: 1% Uvinul T- | | | | |
| 150- | | | | |
| Hydrocharged with | | | | |
| No antimicrobial | | | | |
| treatment | | | | |

Tables 2A and 2B demonstrate that a combination of good filtration performance and good antimicrobial can be achieved with the sparingly soluble silver-containing compound Ag₂SO₄ using a variety of processing conditions. Applying the antimicrobial surface treatment after hydrocharging resulted in an improvement in charge retention.

Some samples were tested by TDSC Test Procedure #1 or #2. Table 2C reports the effective charge density (microC/m²) measured for each sample that was tested.

TABLE 2C
Effective Charge Density for Ag₂SO₄ Treated Electrets

| | Effective Charge | Effective Charge |
|---|---|---|
| | Density | Density |
| | (microC/m²) via | (microC/m²) via |
| | TSDC Test | TSDC Test |
| Sample Description | Procedure #1 | Procedure #2 |
| 2-A: 1% TSM- | — | 1.7 |
| Hydrocharged then | | |
| antimicrobial | | |
| treatment | | |
| 2-D: 1% Uvinul T- | 0.7 | 1.5 |
| 150- | | |
| Hydrocharged then | | |
| antimicrobial | | |
| treatment | | |
| 2-E: 1% Uvinul T- | 1.0 | 1.3 |
| 150-Antimicrobial | | |
| treatment then | | |
| Hydrocharged | | |

### Example Set #3

### Rose Bengal Antimicrobial Treatment of Electret Filters

### Example Preparation

Two polypropylene melt blown microfiber nonwoven (BMF) webs were prepared as described above using PP3960 resin from TOTAL PETROCHEMICALS. Each web contained 1 wt % of either Uvinul T-150 or TSM as a charging additive.

Several 8 inch×36 inch pieces of the same (BMF) webs described were cut and treated with Antimicrobial Treatment Solution #3 (rose bengal) via Treatment Method #2. The webs containing Uvinul T-150 were charged by the Charging Method #2 (corona charging) followed by Charging Method #1 (hydrocharging) either before or after antimicrobial treatment whereas the webs containing TSM were charged by Charging Method #1 (hydrocharging) either before or after antimicrobial treatment to form antimicrobial electret filters. The processing sequence of antimicrobial treatment and hydrocharging is described in Table 3A. The rose bengal concentration of the dried web was 0.01 mg/cm².

The samples were tested for filtration and antimicrobial performance as described in Example Set 2. The test results are reported in the following Tables 3A and 3B.

TABLE 3A
Filtration performance for Rose Bengal treated electrets

| | ΔP Initial | % Pen | | ΔP Aged | % Pen | | % Charge |
|---|---|---|---|---|---|---|---|
| Sample Description | (mm H₂O) | Initial | Q₀ | (mm H₂O) | Aged | Q₃ | Retention |
| 3-A: 1% TSM- | 2.17 | 6.66 | 1.27 | 2.32 | 36.88 | 0.44 | 34% |
| Hydrocharged then | | | | | | | |
| antimicrobial | | | | | | | |
| treatment | | | | | | | |
| 3-B: 1% TSM- | 2.25 | 18.30 | 0.76 | 2.04 | 29.80 | 0.61 | 80% |
| Antimicrobial | | | | | | | |
| treatment then | | | | | | | |
| Hydrocharged | | | | | | | |
| Control | 2.33 | 1.10 | 1.94 | 2.33 | 1.83 | 1.72 | 89% |
| 3-C: 1% TSM- | | | | | | | |
| Hydrocharged with | | | | | | | |
| No antimicrobial | | | | | | | |
| treatment | | | | | | | |
| 3-D: 1% Uvinul | 2.12 | 6.66 | 1.32 | 2.18 | 5.69 | 1.33 | 100% |
| T-150- | | | | | | | |
| Hydrocharged then | | | | | | | |
| antimicrobial | | | | | | | |
| treatment | | | | | | | |
| 3-E: 1% Uvinul T- | 2.00 | 8.96 | 1.22 | 2.00 | 11.08 | 1.11 | 91% |
| 150- Antimicrobial | | | | | | | |
| treatment then | | | | | | | |
| Hydrocharged | | | | | | | |
| Control | 2.18 | 4.11 | 1.47 | 2.07 | 6.56 | 1.35 | 92% |
| 3-F: 1% Uvinul | | | | | | | |
| T-150- | | | | | | | |
| Hydrocharged with | | | | | | | |
| No antimicrobial | | | | | | | |
| treatment | | | | | | | |

Table 3A demonstrates that suitable charge retention can also be obtained with photosensitive antimicrobial agents such as rose bengal that form reactive oxygen species.

TABLE 3B
Antimicrobial Performance for Rose Bengal Treated Electrets

| | | % | | |
|---|---|---|---|---|
| | | Microbial | | % Microbial |
| | | Load | | Load |
| | staph | Reduction | pseudomonas | Reduction |
| Sample | aureus | staph | aeruginosa | pseudomonas |
| Description | (CFU/ml) | aureus | (CFU/ml) | aeruginosa |
| 3-A: 1% TSM- | 0.00 | 100.00 | 2.00E+07 | 77 |
| Hydrocharged then | | | | |
| antimicrobial | | | | |
| treatment | | | | |
| 3-B: 1% TSM- | 5.33E+05 | 89.48 | 1.09E+08 | None |
| Antimicrobial | | | | |
| treatment then | | | | |
| Hydrocharged | | | | |
| Control | 5.06E+06 | — | 8.75E+07 | — |
| 3-C: | | | | |
| 1% TSM- | | | | |
| Hydrocharged with | | | | |
| No antimicrobial | | | | |
| treatment | | | | |
| 3-D: 1% Uvinul T- | 1.25E+01 | 99.999 | 2.41E+07 | None |
| 150- | | | | |
| Hydrocharged then | | | | |
| antimicrobial | | | | |
| treatment | | | | |
| 3-E: 1% Uvinul T- | 1.05E+06 | 46.66 | 1.04E+08 | None |
| 150-Antimicrobial | | | | |
| treatment then | | | | |
| Hydrocharged | | | | |
| Control | 1.97E+06 | — | 3.13E+06 | — |
| 3-F: 1% Uvinul T- | | | | |
| 150- | | | | |
| Hydrocharged with | | | | |
| No antimicrobial | | | | |
| treatment | | | | |

Table 3B demonstrates that only hydrocharging before applying the (rose bengal) antimicrobial surface treatment resulted in antimicrobial efficacy.

### Example Set #4

### Rose Bengal and Ag₂SO₄ Antimicrobial Treatment of Electret Filters

Several 8 inch×36 inch pieces of the same (BMF) web containing 1 wt % Uvinul T-150 as previously described were cut and charged by the Charging Method #3 (corona pretreatment and hydrocharging). Each piece of web was then treated with the Antimicrobial Treatment Solution #3 (rose bengal) via Treatment Method #2 resulting in a concentration of 0.01 mg/cm². The fully dried pieces of web were then treated with Antimicrobial Treatment Solution #2 (Ag₂SO₄) via Treatment Method #2 resulting in a concentration of 0.12 mg/cm².

The filtration performance is expected be the same as reported in Table 3A. The samples were tested for antimicrobial performance as described in Example Set 2. The test results are reported in the following Tables 4A.

TABLE 4A
Antimicrobial Performance for Rose Bengal and Ag₂SO₄ Treated Electrets

| | | % Load | | % Load |
|---|---|---|---|---|
| | staph | Reduction | pseudomonas | Reduction |
| Sample | aureus | staph | aeruginosa | pseudomonas |
| Description | (CFU/ml) | aureus | (CFU/ml) | aeruginosa |
| 4-A: 1% Uvinul T- | 5.63E+01 | 99.997 | 4.64E+03 | 99.85 |
| 150- | | | | |
| Hydrocharged then | | | | |
| antimicrobial | | | | |
| treatments | | | | |
| 4-B: 1% Uvinul T- | 1.97E+06 | — | 3.13E+06 | — |
| 150- | | | | |
| Hydrocharged with | | | | |
| No antimicrobial | | | | |
| treatment | | | | |

In contrast to the use of rose bengal alone (3-D), treatment of the combination of rose bengal with Ag₂SO₄ provided a load reduction of 99.997% for S. Aureus and also provided a load reduction of 99.85% of P. Aeruginosa.

### Example Set #5

### Ag(II)O Antimicrobial Surface Treatment of Electret Filter Media

### Example Preparation

Several 8 inch×36 inch pieces of the same (BMF) web containing 1 wt % Uvinul T-150 as previously described were cut and treated with Antimicrobial Treatment Solution #1 (Ag(II)O) via Treatment Method #2 resulting in silver oxide concentration on the web of 0.38 mg/cm². The webs containing Uvinul were charged by the Charging Method #2 (corona charging) followed by Charging Method #1 (hydrocharging) either before or after antimicrobial treatment whereas the webs containing TSM were charged by Charging Method #1 (hydrocharging) either before or after antimicrobial treatment to form antimicrobial electret filters. The processing sequence of antimicrobial treatment and hydrocharging is described in Table 5A.

The samples were tested for filtration and antimicrobial performance as described in Example Set 2. The test results are reported in the following Tables 5A and 5B.

TABLE 5A
Filtration Performance for Ag(II)O Treated Electrets

| | | % | | | % | | % |
|---|---|---|---|---|---|---|---|
| | ΔP Initial | Pen | | ΔP Aged | Pen | | Charge |
| Sample Description | (mm H₂O) | Initial | Q₀ | (mm H₂O) | Aged | Q₃ | Retention |
| 5-A: 1% TSM- | 2.15 | 2.96 | 1.66 | 1.97 | 5.25 | 1.50 | 90% |
| Hydrocharged then | | | | | | | |
| antimicrobial | | | | | | | |
| treatment | | | | | | | |
| 5-B: 1% TSM- | 2.18 | 1.00 | 2.12 | 2.42 | 1.61 | 1.72 | 81% |
| Antimicrobial | | | | | | | |
| treatment then | | | | | | | |
| Hydrocharged | | | | | | | |
| 5-C: Control | 2.33 | 1.10 | 1.94 | 2.33 | 1.83 | 1.72 | 89% |
| 3-C: 1% TSM- | | | | | | | |
| Hydrocharged with | | | | | | | |
| No antimicrobial | | | | | | | |
| treatment | | | | | | | |
| 5-D: 1% Uvinul | 2.08 | 7.74 | 1.24 | 2.14 | 8.00 | 1.18 | 95% |
| T-150- | | | | | | | |
| Hydrocharged then | | | | | | | |
| antimicrobial | | | | | | | |
| treatment | | | | | | | |
| 5-E: 1% Uvinul T- | 2.13 | 7.32 | 1.23 | 2.10 | 8.07 | 1.21 | 99% |
| 150-Antimicrobial | | | | | | | |
| treatment then | | | | | | | |
| Hydrocharged | | | | | | | |
| Control | 2.18 | 4.11 | 1.47 | 2.07 | 6.56 | 1.35 | 92% |
| 5-F: 1% Uvinul | | | | | | | |
| T-150- | | | | | | | |
| Hydrocharged with | | | | | | | |
| No antimicrobial | | | | | | | |
| treatment | | | | | | | |

TABLE 5B
Antimicrobial Performance for Ag(II)O Treated Electrets

| | | % Load | | % Load |
|---|---|---|---|---|
| | staph | Reduction | pseudomonas | Reduction |
| Sample | aureus | staph | aeruginosa | pseudomonas |
| Description | (CFU/ml) | aureus | (CFU/ml) | aeruginosa |
| 5-A: 1% TSM- | <5 | 99.97% | 2.33E+02 | 82% |
| Hydrocharged then | | | | |
| antimicrobial | | | | |
| treatment | | | | |
| 5-B: 1% TSM- | 2.43E+02 | 98.4% | 6.37E+00 | 99.5% |
| Antimicrobial | | | | |
| treatment then | | | | |
| Hydrocharged | | | | |
| 5-C: Control | 1.49E+04 | — | 1.30E+03 | — |
| 1% TSM- | | | | |
| Hydrocharged with | | | | |
| No antimicrobial | | | | |
| treatment | | | | |
| 5-D: 1% Uvinul T- | 8.91E+01 | 96% | 4.46E+01 | 99.998% |
| 150- | | | | |
| Hydrocharged then | | | | |
| antimicrobial | | | | |
| treatment | | | | |
| 5-E: 1% Uvinul-T- | 2.87E+02 | 88% | 1.02E+01 | 99.9996% |
| 150 Antimicrobial | | | | |
| treatment then | | | | |
| Hydrocharged | | | | |
| 5-F: Control | 2.32E+03 | — | 2.46E+06 | — |
| 1% Uvinul-T-150 | | | | |
| Hydrocharged with | | | | |
| No antimicrobial | | | | |
| treatment | | | | |

Tables 5A and 5B demonstrate that a combination of good filtration performance and good antimicrobial can be achieved with the sparingly soluble silver-containing compound Ag(II)O using a variety of processing conditions. Applying the antimicrobial surface treatment after hydrocharging resulted in an improvement in filtration and antimicrobial performance.

### Example Set #6

### AgNO₃ Antimicrobial Surface Treatment of Electret Filter Media

### Example Preparation

Several 8 inch×36 inch pieces of the same (BMF) web containing 1 wt % Uvinul T-150 previously described were cut and treated with Antimicrobial Treatment Solution #5 (AgNO₃) via Treatment Method #2 resulting in the dried web having a AgNO₃ concentration of 1.8 mg/cm². The webs were charged by the Charging Method #3 (corona charging followed by hydrocharging). The samples were tested for filtration and antimicrobial performance as described in Example Set 2. The test results are reported in the following Tables 6A and 6B.

TABLE 6A
Filtration Performance for Treated AgNO₃ Electrets

| | ΔP | % | | | % | | |
|---|---|---|---|---|---|---|---|
| Sample | Initial | Pen | | ΔP Aged | Pen | | % Charge |
| Description | (mm H₂O) | Initial | Q₀ | (mm H₂O) | Aged | Q₃ | Retention |
| 6A-1% Uvinul T- | 2.27 | 17.53 | 0.78 | 2.28 | 14.18 | 0.86 | 111 |
| 150-Charged by | | | | | | | |
| Method #3 then | | | | | | | |
| antimicrobial | | | | | | | |
| treatment | | | | | | | |
| Control | 2.53 | 3.99 | 1.28 | 2.33 | 4.41 | 1.34 | 105 |
| 1% Uvinul-T-150 | | | | | | | |
| Charged by | | | | | | | |
| Method #3 | | | | | | | |
| with No | | | | | | | |
| antimicrobial | | | | | | | |
| treatment | | | | | | | |

TABLE 6B
Antimicrobial Performance for AgNO₃ Treated Electrets (I have
controls and raw data for the table below if needed)

| | % Load | % Load |
|---|---|---|
| | Reduction | Reduction |
| Sample | staph | pseudomonas |
| Description | aureus | aeruginosa |
| 6A-1% Uvinul- | 99.97 | 99.999 |
| Charged by Method | | |
| #3 then | | |
| antimicrobial | | |
| treatment | | |

Tables 6A and 6B demonstrate that a combination of good filtration performance and good antimicrobial can be achieved with the silver-containing compound AgNO₃.

### Example Set #7

### PHMB Antimicrobial Surface Treatment of Electret Filter Media

### Example Preparation

Several 8 inch×36 inch pieces of the same (BMF) web containing 1 wt % Uvinul T-150 previously described were cut and treated with Antimicrobial Treatment Solution #6 (PHMB) via Treatment Method #2 resulting in the dried web having a PHMB concentration of 0.9 mg/cm². The webs were charged by the Charging Method #3 (corona charging followed by hydrocharging). The samples were tested for filtration and antimicrobial performance as described in Example Set 2. The test results are reported in the following Tables 7A and 7B.

TABLE 7A
Filtration Performance for Treated PHMB Electrets

| | ΔP | | | | % | | % |
|---|---|---|---|---|---|---|---|
| Sample | Initial | % Pen | | ΔP Aged | Pen | | Charge |
| Description | (mm H₂O) | Initial | Q₀ | (mm H₂O) | Aged | Q₃ | Retention |
| 7A-1% Uvinul T- | 2.35 | 18.98 | 0.71 | 2.50 | 18.18 | 0.69 | 96 |
| 150-Charged by | | | | | | | |
| Method #3 then | | | | | | | |
| antimicrobial | | | | | | | |
| treatment | | | | | | | |
| Control | 2.53 | 3.99 | 1.28 | 2.33 | 4.41 | 1.34 | 105 |
| 1% Uvinul-T-150 | | | | | | | |
| Charged by Method #3 | | | | | | | |
| with No antimicrobial | | | | | | | |
| treatment | | | | | | | |

TABLE 7B
Antimicrobial Performance for PHMB Treated Electrets

| | % Load | % Load |
|---|---|---|
| | Reduction | Reduction |
| Sample | staph | pseudomonas |
| Description | aureus | aeruginosa |
| 7A-1% Uvinul- | 99.61 | 99.999 |
| Charged by Method | | |
| #3 then | | |
| antimicrobial | | |
| treatment | | |

Tables 7A and 7B demonstrate that a combination of good filtration performance and good antimicrobial can be achieved with PHMB.

### Comparative Example Set #8

### Quaternary Amine Antimicrobial Surface Treatment of Electret Filter Media

### Example Preparation

Several 8 inch×36 inch pieces of the same (BMF) web containing 1 wt % Uvinul T-150 previously described were cut and treated with Antimicrobial Treatment Solution #4 (quaternary amine, Bardac 208M) via Treatment Method #2. The webs were charged by the Charging Method #3 (corona charging followed by hydrocharging). The samples were tested for filtration and antimicrobial performance as described in Example Set 2. The test results are reported in the following Tables 8A and 8B.

TABLE 8A
Filtration Performance for Quaternary Amine Treated Electrets

| | ΔP | | | | % | | % |
|---|---|---|---|---|---|---|---|
| | Initial | % Pen | | ΔP Aged | Pen | | Charge |
| Sample Description | (mm H₂O) | Initial | Q₀ | (mm H₂O) | Aged | Q₃ | Retention |
| 8-A: 1% Uvinul-T- | 3.03 | 74.60 | 0.10 | 3.03 | 73.90 | 0.10 | 102 |
| 150 Charged by | | | | | | | |
| Method #3 then | | | | | | | |
| antimicrobial | | | | | | | |
| treatment | | | | | | | |
| Control | 2.53 | 3.99 | 1.28 | 2.33 | 4.41 | 1.34 | 105 |
| 8-B: 1% Uvinul T- | | | | | | | |
| 150-Charged by | | | | | | | |
| Method #3 with No | | | | | | | |
| antimicrobial | | | | | | | |
| treatment | | | | | | | |
| Control | 2.73 | 74.35 | 0.11 | 2.27 | 78.67 | 0.11 | 98 |
| 8-C: 1% Uvinul T- | | | | | | | |
| 150-Not Charged | | | | | | | |
| and No antimicrobial | | | | | | | |
| treatment | | | | | | | |

TABLE 8B
Antimicrobial Performance for Quaternary Amine Treated Electrets

| | % Load | % Load |
|---|---|---|
| | Reduction | Reduction |
| Sample | staph | pseudomonas |
| Description | aureus | aeruginosa |
| 8-A: 1% Uvinul T- | 99.98 | 99.993 |
| 150-Charged by | | |
| Method #3 then | | |
| antimicrobial | | |
| treatment | | |

Tables 8A and 8B demonstrate that application of the quaternary amine antimicrobial to the charged filter media results in a good antimicrobial performance, but loss of filtration performance surmised to be caused by the quaternary amine discharging the surface charge back to its uncharged state.

### X-Ray Discharge of Electret Filter Media:

Using the procedure described above, selected samples of filter media were exposed to ionizing x-rays. Table 9 reports the filtration performance of each sample prior to exposure to x-rays (time=0 min), after 30 min of total x-ray exposure, and after 40 min of total x-ray exposure.

TABLE 9
Performance of filter media after repeated exposure to x-ray radiation

| | Filtration Performance after Exposure to X-rays | | | | | | | | | |
|---|---|---|---|---|---|---|---|---|---|---|
| | Exposure = 0 min | | | | | | | | | |
| Ex. | ΔP | | | Exposure = 30 min | | | Exposure = 40 min | | | % Pen |
| No. | (mm H₂O) | % Pen | QF | ΔP | % Pen | QF | ΔP | % Pen | QF | Ratio |
| 2-A | 2.20 | 1.85 | 1.81 | 2.10 | 68.40 | 0.18 | 2.10 | 75.20 | 0.14 | 97.5 |
| 2-D | 2.40 | 7.78 | 1.06 | 2.30 | 73.20 | 0.14 | 2.30 | 75.80 | 0.12 | 89.7 |
| 2-E | 2.30 | 10.30 | 0.99 | 2.30 | 75.30 | 0.12 | 2.30 | 75.50 | 0.12 | 86.4 |
| *2-F | 1.60 | 5.06 | 1.86 | 1.60 | 74.80 | 0.18 | 1.60 | 75.70 | 0.17 | 93.3 |
| 6-A | 2.60 | 16.10 | 0.70 | 2.60 | 73.40 | 0.12 | 2.60 | 71.30 | 0.13 | 77.4 |
| 7-A | 2.70 | 20.60 | 0.59 | 2.60 | 74.40 | 0.11 | 2.60 | 72.20 | 0.13 | 71.5 |
| **8-A | 3.50 | 63.30 | 0.13 | 3.40 | 74.40 | 0.09 | 3.40 | 70.70 | 0.10 | 10.5 |

*Control
**Comparative
$\% Pen Ratio = \% Penetration Ratio = \frac{( \% Pen at 40 min - \% Pen at 0 min ) \times 100}{\% Pen at 40 min}$

1. An antimicrobial electret material comprising a unitary web comprising an antimicrobial surface treatment; wherein the web exhibits a microbial load reduction of at least about 90% for either gram positive or gram negative pathogens, when tested pursuant to AATCC Method 100-2004; and has a % Penetration Ratio of at least 50% at a face velocity of 6.9 cm/s when tested pursuant the X-ray Discharge Test.

2. An antimicrobial electret material comprising a unitary web comprising an antimicrobial surface treatment; wherein the web exhibits a microbial load reduction of at least about 90% for either gram positive or gram negative pathogens, when tested pursuant to AATCC Method 100-2004; and has an initial Quality Factor of at least 0.3 at a face velocity of 6.9 cm/s and a Quality Factor of at least 50% less than the initial Quality Factor after 40 minutes when tested pursuant the X-ray Discharge Test.

3. The antimicrobial electret material of claim 1 wherein the web is a polymeric fibrous web.

4. The antimicrobial material of claim 1 wherein the web exhibits a microbial load reduction of at least about 90% for gram positive and gram negative pathogens, when tested pursuant to AATCC Method 100-2004.

5. The antimicrobial material of claim 1 wherein the web exhibits a microbial load reduction of at least about 99% for gram positive or gram negative pathogens, when tested pursuant to AATCC Method 100-2004.

6. The antimicrobial material of claim 1 wherein the web exhibits a microbial load reduction of at least about 99% for gram positive and gram negative pathogens, when tested pursuant to AATCC Method 100-2004.

7. The antimicrobial material of claim 2 wherein the web exhibits a Q₀ of at least 0.6 when measured using DOP aerosol at a face velocity of 6.9 cm/s.

8. The antimicrobial material of claim 2 wherein the web exhibits a Q₀ of at least 1.0 when measured using DOP aerosol at a face velocity of 6.9 cm/s.

9. The antimicrobial material of claim 1 wherein the web exhibits a charge retention of at least 75%.

10. The antimicrobial material of claim 1 wherein the web exhibits a charge retention of at least 90%.

11. The antimicrobial electret material of claim 1 wherein the antimicrobial surface treatment comprises a silver-containing compound.

12. The antimicrobial electret material of claim 1 wherein the silver-containing compound is a sparingly soluble silver-containing compound.

13. The antimicrobial electret material of claim 1 wherein the silver-containing compound is selected from the group consisting of silver oxide, silver sulfate, silver acetate, silver chloride, silver phosphate, silver stearate, silver thiocyanate, silver proteinate, silver carbonate, silver sulfadiazine, silver alginate, and combinations thereof.

14. The antimicrobial electret material of claim 12 wherein the surface treatment further comprises an ammonium-containing compound.

15. The antimicrobial electret material of claim 1 wherein the antimicrobial surface treatment comprises a photosensitive antimicrobial agent that forms reactive oxygen species.

16. The antimicrobial electret material of claim 15 wherein the antimicrobial surface treatment comprises a xanthene dye.

17. The antimicrobial electret material of claim 1 wherein the antimicrobial surface treatment comprises a biguanide compound.

18. An antimicrobial electret material comprising an electret web comprising an antimicrobial surface treatment wherein the surface treatment comprises a sparingly soluble silver-containing compound, a photosensitive antimicrobial agent that forms reactive oxygen species, a biguanide compound, or a combination thereof.

19. The antimicrobial electret material of claim 18 wherein the electret web comprises a sparingly soluble silver-containing compound.

20. The antimicrobial electret material of claim 18 wherein the electret web comprises a photosensitive antimicrobial agent that forms reactive oxygen species.

21. The antimicrobial electret material of claim 18 wherein the electret material comprising a trianilino triazine charge additive.

22. The antimicrobial electret material of claim 18 wherein the electret web comprises a sparingly soluble silver-containing compound and a photosensitive antimicrobial agent that forms reactive oxygen species.

23. A method of making an antimicrobial electret material comprising
providing a web;
charging the web;
applying an antimicrobial treatment solution to the charged web.

24. The method of claim 23 wherein the antimicrobial treatment solution comprises a sparingly soluble silver-containing compound, a photosensitive antimicrobial agent that forms reactive oxygen species, a biguanide compound, and combinations thereof.

25. The method of claim 23 wherein the charging comprises hydrocharging.

26. The method of claim 23 wherein the antimicrobial treatment solution is applied concurrently with hydrocharging the web.

27. The method of claim 25 wherein the antimicrobial treatment solution comprises a photosensitive antimicrobial agent that forms reactive oxygen species.

28. The method of claim 27 wherein the antimicrobial agent is a xanthene dye.
